(19) United States
(12) Patent Application Publication
(10) Pub. No.: US 2008/0000514 A1
(43) Pub. Date: Jan. 3, 2008

(54) Solar Energy Concentrator

(76) Inventors: Kuo-Len Lin, Wugu Township (TW); Ken Hsu, Wugu Township (TW); Wen-Jung Liu, Wugu Township (TW); Hai-Rui Ye, Wugu Township (TW)

Correspondence Address: HDSL, 4331 STEVENS BATTLE LANE, FAIRFAX, VA, 22033, US

(21) Appl. No.: 11/428,366

(22) Filed: Jun. 30, 2006

(51) Int. Cl. H02N 6/00

(52) U.S. Cl. 136/246

(57) ABSTRACT

A solar energy concentrator has a solar panel comprising a plurality of solar cells, a solar energy concentrating plate including a plurality of concentrating elements, each of the concentrating elements corresponding to one solar cell, and a supporting member supporting the solar panel and the solar energy concentrating plate. The solar energy concentrating plate concentrates sunbeams to the solar panel.

### BACKGROUND

The present invention relates to a solar energy concentrator, and more particularly to a solar energy concentrator having a high solar energy concentrating efficiency.

Currently the solar energy concentrator has a plurality of solar panel, which can be adjusted to face the sunbeams according to the direction and intensity of the sunbeams, for collecting the solar energy and converting the solar energy to the electrical potential energy for accumulation. Thus, in the current solar energy concentrator, a solar panel, a solar energy concentrator and a tracking element are necessary elements for assuring a good solar energy concentrating efficiency.

For concentrating the solar energy to a plurality of solar cells of the solar panel, a single-piece collector lens is provided. The collector lens has a predetermined curvature and has a large area similar to that of the solar panel. However, the manufacturing process of the single-piece collector lens having a large area is complex and difficult, which adds the cost and lowers the productivity. Moreover, the single collector lens can not transmit sunbeams to each of the solar cells, that is, only a part of the solar cells can be efficiently utilized to concentrate the solar energy. Therefore, the solar panel can not attain an uniform and efficient solar energy collection over the whole area thereof.

As shown in Taiwan Patent Publication No. 545519, a solar energy concentrating structure has a plurality of heat concentrating elements parallel to each other. Each heat concentrating element is an arc-shaped reflector having a plurality concentric vacuum tubes therein. Each vacuum tube has a heat concentrating plate. In operation, the arc-shaped reflector faces the sunbeams for collecting solar irradiation in the heat concentrating plate.

Taiwan Patent Publication No. 543714 discloses an alternative solar energy concentrating device, which utilizes a focus adjustor to adjust the focus of a in-plane lens for projecting the sunbeams to the solar panel.

Taiwan Patent Publication No. 484702 discloses another alternative solar energy concentrating device, which utilizes a holographic lens to replace a conventional focusing lens for improving the concentrating efficiency.

Though the aforementioned related technologies develop a kind of solutions, the lens used in the solar energy concentrating device is a single-piece and large-area. The problem of only a part of the solar cells being efficiently utilized to concentrate the solar energy is still not be resolved. Thus, the concentrating efficiency of the solar energy concentrating device can not be improved.

### BRIEF SUMMARY

Accordingly, the present invention is to provide a solar energy concentrator, which is facilitated and conveniently in operation.

An exemplary solar energy concentrator has a solar panel comprising a plurality of solar cells, a solar energy concentrating plate comprising a plurality of concentrating elements, each of the concentrating elements corresponding to one solar cell, and a supporting member supporting the solar panel and the solar energy concentrating plate. The solar energy concentrating plate concentrates sunbeams to the solar panel.

The supporting member has an upper supporting frame and a lower supporting plate, the lower supporting plate supporting the upper supporting frame.

The supporting member further defines a through hole between the upper supporting frame and the lower supporting plate.

Other advantages and novel features will become more apparent from the following detailed description when taken in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, exploded isometric view of a solar energy concentrator according to a first embodiment of the invention;

FIG. 2 is a schematic, assembly view of the solar energy concentrator of FIG. 1;

FIG. 3 is a side elevation view of the solar energy concentrator of FIG. 1;

FIG. 4 is an another side elevation view of the solar energy concentrator of FIG. 1; and

FIG. 5 is a schematic view of the solar energy concentrator of FIG. 1, showing the light beams concentrating path.

### DETAILED DESCRIPTION

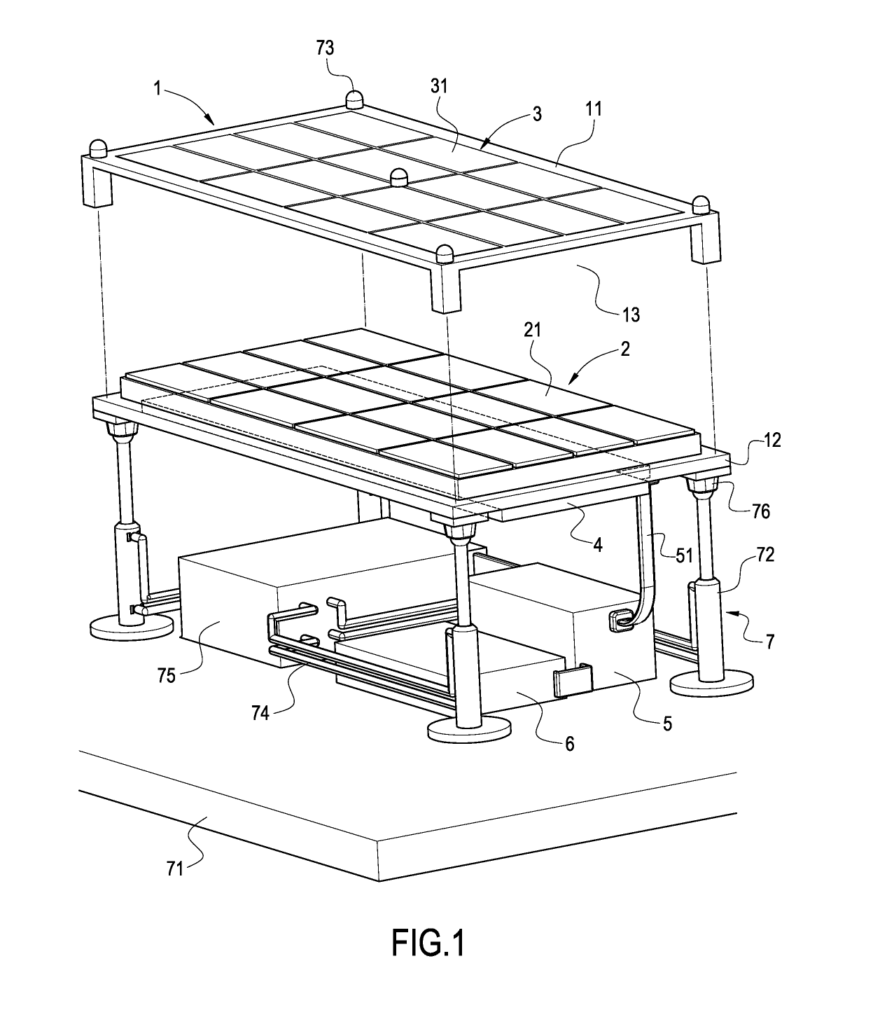

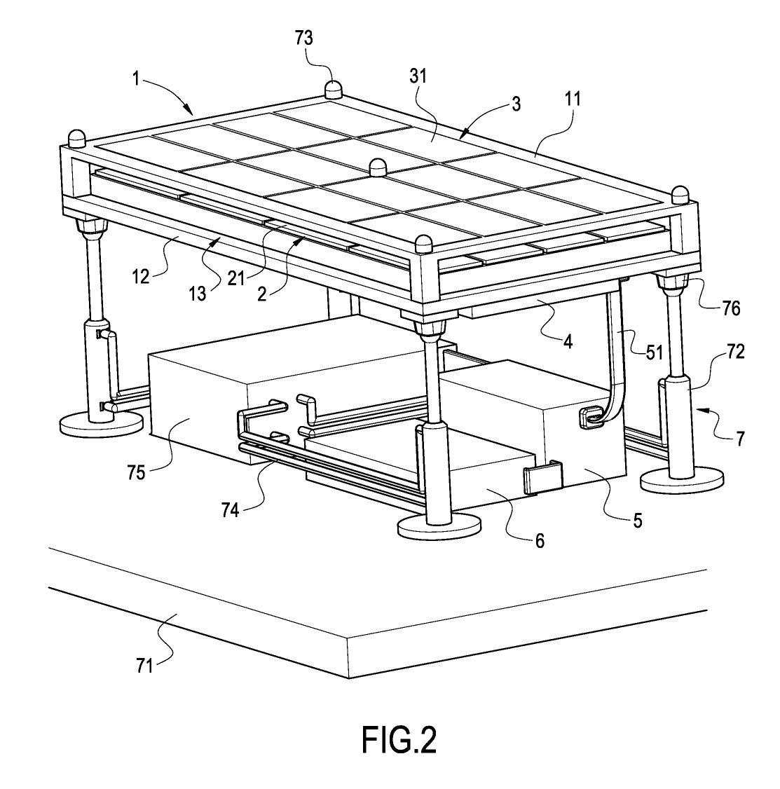

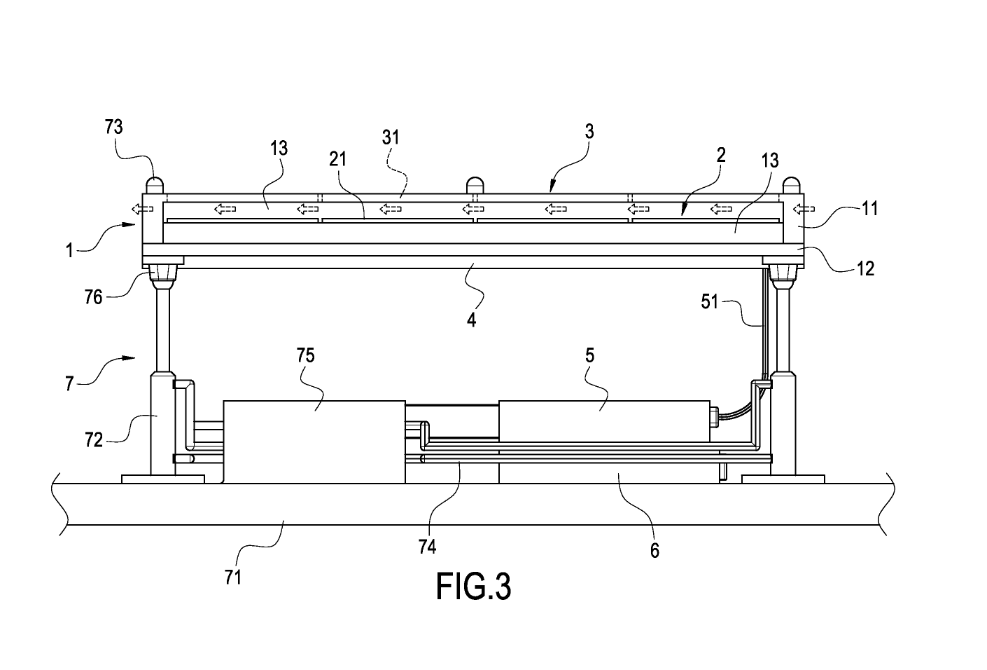

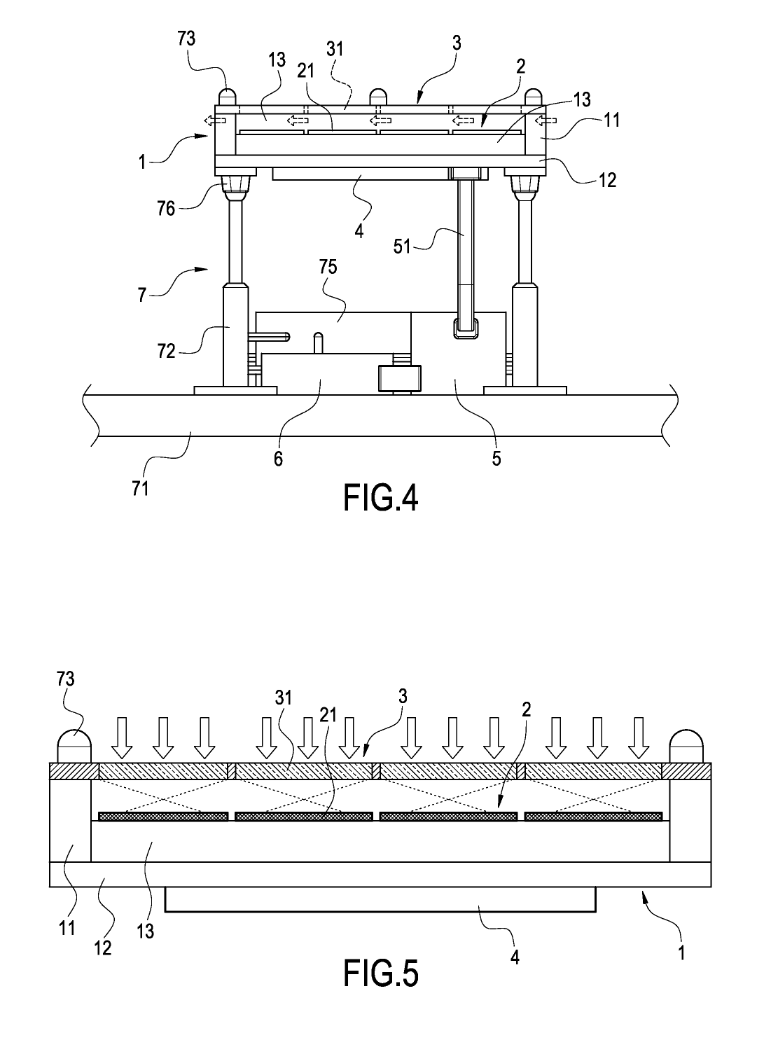

Referring to FIGS. 1-5, a solar energy concentrator has a solar panel 2, a solar energy concentrating plate 3, a supporting member 1, an incubator plate 4, a converter 5, a power accumulator 6, and a pedestal 7. The supporting member 1 supports the solar panel 2 and the solar energy concentrating plate 3, which is fixed on the pedestal 7. The incubator 4 is disposed under the solar panel 2

The supporting member 1 has an upper supporting frame 11 and a lower supporting plate 12. The upper supporting frame 11 is fixed on the lower supporting plate 12 spacing a special distance to form a space 13 therebetween. The space 13 is preferably a through hole for atmospheric ventilation and heat dispersion.

The solar panel 2 has a plurality of solar cells 21 arranged in a matrix. The plurality of solar cells 21 is uniformly distributed on the lower supporting plate 12.

The solar energy concentrating plate 3 has a plurality of concentrating elements 31 arranged in a matrix, which the concentrating elements 31 are fixed on the upper supporting frame 11. The concentrating elements 31 are lenses made from glass or acryl, each having a predetermined curvature. Each of the concentrating elements 31 is corresponding to a solar cell 21 for efficiently concentrating sunbeams to the solar cell 21.

The converter 5 and the power accumulator 6 are disposed under the solar panel 2. The converter 5 electrically connects with the solar panel 2 through a flexible printed circuit board (FPCB) 51, for converting the heat energy and optical energy concentrated in the solar panel 2 to the electrical potential energy, and accumulates the electrical potential energy into the power accumulator 6.

The pedestal 7 has a base 71 and a plurality of supporting shafts 72 (preferably four supporting shafts), a plurality of photo sensors 73, a plurality of universal joints 76, and a pump 75. The plurality of photo sensors 73 are disposed on the upper supporting frame 11 of the supporting member 1 for detecting the direction and position of sunbeams. The supporting shaft 72 holds the supporting member 1. One end of each supporting shaft 72 is fixed on the base 71, and the other end of each supporting shaft 72 engages with the lower supporting plate 12 of the supporting member 1 through one universal joint 76. The supporting shaft 72 is a pressure expansion link, connecting with the pump 75 through a pipe 74. The pump 75 can be a hydraulic pump or pneumatic pump, which can drive each supporting shaft 72 to expand and contract in the vertical direction through outputting a pressure.

In assembly, the supporting member 1 is fixed on the pedestal 7 by the connection of the lower supporting plate 12 of the supporting member 1 and the supporting shaft 72. The lower supporting plate 12 connects with the supporting member 1 through one universal joint 76. The lower supporting plate 12 spaces with the upper supporting frame 11 of the supporting member 1 and defines the space 13 therebetween. The solar energy concentrating plate 3 is engaged on the upper supporting frame 11 and the solar panel 2 is disposed on the lower supporting plate 12. Each of the concentrating elements 31 of the solar energy concentrating plate 3 faces one solar cell 21 of the solar panel 2. In addition, the plurality of photo sensor 73 is set on the upper supporting frame 11 of the supporting member 1 for detecting sunbeams.

In operation, when the photo sensor 73 detects the direction of the sunbeams, the pump 75 drives the plurality of supporting shafts 72 to expand and contract in the vertical direction according to the detecting signal from the photo sensor 73, respectively. The solar energy concentrating plate 3 and the solar panel 2 on the supporting member 1 are adjusted to face the sunbeams through the cooperation of the plurality universal joints 76 and the plurality of supporting shafts 72. Each of the concentrating elements 31 of the solar energy concentrating plate 3 concentrates sunbeams to one corresponding solar cell 21 of the solar panel 2. The converter 5 converts the heat energy and optical energy concentrated in the solar panel 2 to the electrical potential energy, and transmits the electrical potential energy into the power accumulator 6 to accumulate. The space 13 between the lower supporting plate 12 and the upper supporting frame 11, and the incubator plate 4 attached on the solar panel 2 efficiently disperses the heat produced in the process of the solar panel 2 absorbing optical energy and heat energy of sunbeams.

The solar energy concentrating plate has a plurality of solar cells 21 and a plurality of concentrating elements 31. Each of the concentrating elements 31 of the solar energy concentrating plate 3 faces one solar cell 21 and concentrates sunbeams to one corresponding solar cell 21 of the solar panel 2. Thus, every concentrating element 31 can project sunbeams to the corresponding solar cell 21, and each solar cell 21 can effectively concentrate the solar energy. In addition, the space 13 between the lower supporting plate 12 and the upper supporting frame 11, and the incubator plate 4 attached on the solar panel 2, which can efficiently disperse the heat produced in the process of the solar panel 2 absorbing optical energy and heat energy of sunbeams.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A solar energy concentrator comprising:
a solar panel comprising a plurality of solar cells;
a solar energy concentrating plate comprising a plurality of concentrating elements, each of the concentrating elements corresponding to one solar cell; and
a supporting member supporting the solar panel and the solar energy concentrating plate;
wherein the solar energy concentrating plate concentrating sunbeams to the solar panel.

2. The solar energy concentrator as claimed in claim 1, wherein the supporting member comprises an upper supporting frame and a lower supporting plate, the lower supporting plate supporting the upper supporting frame.

3. The solar energy concentrator as claimed in claim 2, wherein the supporting member includes a through hole between the upper supporting frame and the lower supporting plate.

4. The solar energy concentrator as claimed in claim 2, wherein the upper supporting frame and the lower supporting plate space a special distance to form a space therebetween.

5. The solar energy concentrator as claimed in claim 4, wherein the space is a through hole.

6. The solar energy concentrator as claimed in claim 2, wherein the solar panel is formed on the lower supporting plate, and the solar energy concentrating plate is fixed on the upper supporting frame.

7. The solar energy concentrator as claimed in claim 1, further comprising an incubator plate attached to the solar panel.

8. The solar energy concentrator as claimed in claim 1, further comprising a pedestal supporting the supporting member.

9. The solar energy concentrator as claimed in claim 1, wherein the pedestal comprises:
a base;
a plurality of supporting shafts fixed on the base for holding the supporting member;
a plurality of photo sensor set on the supporting member for detecting the sunbeams; and
a pump connecting with the supporting shaft;
wherein the supporting shaft is a pressure expansion link.

10. The solar energy concentrator as claimed in claim 9, wherein the pump is one of a hydraulic pump and pneumatic pump.

11. The solar energy concentrator as claimed in claim 9, wherein the pump drives each supporting shaft to expand and contract at the vertical direction through outputting a pressure.

12. The solar energy concentrator as claimed in claim 1, further comprising a converter and a power accumulator, the converter electrically connecting with the solar panel through an expandable and contractible printed circuit board (FPCB), for converting the heat energy and optical energy concentrated in the solar panel to the electrical potential energy, and accumulating the electrical potential energy into the power accumulator.
